(19) United States
(12) Patent Application Publication
(10) Pub. No.: US 2024/0388120 A1
(43) Pub. Date: Nov. 21, 2024

(54) PORTABLE, SOLAR-POWERED CAMPSITE SYSTEM FOR CHARGING AND POWERING ELECTRIC AND RECREATIONAL VEHICLES

(71) Applicant: ELECTRIC OUTDOORS, INC., Southfield, MI (US)

(72) Inventors: Josef Hjelmaker, Harbert, MI (US); Joe Van Faasen, Holland, MI (US); Michael Van Steenburg, Novi, MI (US)

(21) Appl. No.: 18/668,996

(22) Filed: May 20, 2024

Related U.S. Application Data
(60) Provisional application No. 63/503,342, filed on May 19, 2023.

(51) Int. Cl. H02J 7/35; B60L 53/51; B60L 53/52; E04H 6/04; H02J 3/38; H02J 7/00; H02J 13/00; H02S 20/30

(52) U.S. Cl. CPC H02J 7/35; E04H 6/04; H02J 3/38; H02J 7/00032; H02J 7/0048; H02J 7/007188; H02J 13/00022; B60L 53/51; B60L 53/52; H02S 20/30

(57) ABSTRACT

A solar-energy derived charging system for use in an off-grid or grid-tied environment to provide electrical power to electrical devices is disclosed. The solar-energy derived charging system includes a support structure for a plurality of photovoltaic cells and an energy storage device in electrical communication with the plurality of photovoltaic cells. A control system is provided configured to monitor and control the operation of the solar-energy derived charging system, the control system in communication with a remote network and including a software application. The software application may be configured to utilize data from the solar-energy derived charging system and secondary source of data to provide reports to the user, and facilitate a user planning and managing their recreational activity.

### CROSS-REFERENCE TO RELATED APPLICATIONS

This application claims the benefit of U.S. Provisional Application No. 63/503,342, filed on May 19, 2023. The entire disclosure of the above application is incorporated herein by reference.

### FIELD

The present invention relates to a solar-energy derived charging system and habitat and, more particularly, to a solar-energy derived charging system and habitat that is capable of use in both grid-tied and off-grid environments to provide electrical energy for hotel loads and charging electrically powered transportation and other electrical devices.

### INTRODUCTION

This section provides background information related to the present disclosure which is not necessarily prior art.

In an ever-growing era of electrification, and next generation needs for mobility and sustainable experiences, enjoying the outdoors is becoming more difficult. Currently there is minimal infrastructure supporting outdoor recreation, such as camping and use of recreational vehicles (RV), in an environmentally sustainable manner. Furthermore, due to changing and/or undesirable whether conditions, terrain, and wildlife, it may be a challenge to enjoy the outdoors and have a positive sustainable camping or RV experience.

Campers, vacationers, and recreational vehicle users (RV'er) will increasingly be likely to own or rent an electric or plug-in hybrid powered vehicle such as an RV, a truck, or offroad vehicle, for example. Additionally, the camper will likely have other equipment that requires electrical energy, such as, lights, cooking stoves/grills, mobile devices, water generators, water heaters, and waste management devices. The camper will quickly discover finding a place to visit, stay, and charge their electric vehicle, as well as power other electrical devices in a sustainable manner, is difficult as there are few outdoor or remote destinations to support such needs for sustainable electrical energy. This task becomes even more difficult when wanting to visit outdoor off-grid camping and vacation sites. Without the availability of such electrical power, the camping experience becomes more “primitive” or requires the use of traditional energy sources such as gasoline and propane, for example. Faced with such tradeoffs, many people may choose not to camp and explore the outdoors, especially if they only have a battery powered electric vehicle.

Entities other than campers are also facing increased electrification issues and are looking for ways to power both grid-tied and off-grid applications. A landowner, campsite owner, or a party organizing a group gathering, such as a music or an art festival, for example, may have a desire to provide sustainable electrical energy to their guests. In order to provide an outdoor sustainable off-grid experience that meets the expectations of campers, such entities will need to provide a source of sustainable electrical energy in a manner that minimizes cost and disruption to the natural environment.

Accordingly, there is a need for a solar-energy derived charging system for use in grid-tied and off-grid environments to provide sustainable electrical energy for the electrical devices of campers, vacationers, and RV'ers, in combination with a habitable enclosure.

### SUMMARY

In concordance with the disclosure, a solar-energy derived charging system for use in grid-tied and off-grid environments to provide sustainable electrical energy for the electrical devices of campers, vacationers, and RV'ers, in combination with a habitable enclosure has surprisingly been discovered. The present technology includes articles of manufacture, systems, and methods that relate to a solar-energy derived charging system for use in both grid-tied and off-grid environments.

In certain embodiments, a solar-energy derived charging system for use in an off-grid or grid-tied environment is provided to supply electrical power to an electrical device. The solar-energy derived charging system may include a control system, an application module integrated with the control system, and one or more photovoltaic cells. The control system may be configured to receive a user input including a travel itinerary. The application module may be integrated with the control system and application module configured to manage an energy allocation from the solar-energy derived charging system based upon the user input including the travel itinerary, the energy allocation accounting for an energy availability and an environmental condition based on the travel itinerary. The photovoltaic cells may be configured to charge an energy storage device managed by the control system to provide an energy supply to an electrical device for a user.

In certain embodiments, a method for providing energy for a recreational activity by a user may include providing a solar-energy derived charging system for use in an off-grid or grid-tied environment to supply electrical power to an electrical device. A software application may be used to input an itinerary for the recreational activity, where the software application and a secondary source of data may be utilized to calculate an electrical energy requirement for the itinerary. In particular, the software application and the secondary source of data may be used to predict a generation of electrical energy by the solar-energy derived charging system during the recreational activity. A report may be provided to a user to predict a sufficiency of the generation of electrical energy by the solar-energy derived charging system during the recreational activity to support the user itinerary. The solar-energy derived charging system may be operated to provide energy for the user itinerary based on the recreational activity.

In certain embodiments, a method for planning a recreational activity by a user is provided that may use a solar-energy derived charging system for use in an off-grid or grid-tied environment to provide electrical energy to an electrical device. The solar-energy derived charging system may include a control system, a wireless communication module, and a software application. The control system may be configured to monitor and control a generation of electrical energy by the solar-energy derived charging system and a use of electrical energy from the solar-energy derived charging system. The wireless communication module may be configured to provide communication between the control system and a remote network, the remote network may be configured to receive and store data from the solar-energy derived charging system, and the software application may be configured to utilize the data and a secondary source of data. The secondary source of data may include a weather condition, a weather forecast, a user travel itinerary, an electrical consumption profile of the electrical device, and/or geographical data.

In certain embodiments, methods may further include utilizing the software application to input an itinerary for the recreational activity and utilizing the software application and the secondary source of data to calculate an electrical energy requirement for the recreational activity. Methods may also include utilizing the software application and the secondary source of data to predict the generation of electrical energy by the solar-energy derived charging system during the recreational activity. A report may be provided to the user predicting a sufficiency of the generation of electrical energy by the solar-energy derived charging system during the recreational activity to support the user travel itinerary. An operation of one or more photovoltaic cells and the solar-energy derived charging system may be adjusted to optimize energy efficiency and meet predicted energy requirements based upon the user travel itinerary.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an elevational view of a solar-energy derived charging system, according to an embodiment of the disclosure;

FIG. 2 is a perspective view of the solar-energy derived charging system of in FIG. 1;

FIG. 3 is a top perspective view of the solar-energy derived charging system of FIG. 1 showing a rotation of a plurality of photovoltaic cells;

FIG. 4 is a series of elevational views of the solar-energy derived charging system of in FIG. 1 depicting a transition of the solar-energy derived charging system from a non-deployed or stored configuration to a deployed configuration;

FIG. 5 is a block diagram illustrating a solar-energy derived charging system, according to an embodiment of the present disclosure.

FIG. 6A is a schematic illustration of a solar-energy derived charging system, according to an embodiment of the disclosure;

FIG. 6B is a schematic illustration of a solar-energy derived charging system, according to an embodiment of the disclosure; and

FIGS. 7A and 7B show a flow diagram illustrating a method for planning a recreational activity by a user utilizing a solar-energy derived charging system, according to an embodiment of the disclosure.

### DETAILED DESCRIPTION

The following description of technology is merely exemplary in nature of the subject matter, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present disclosure provides a solar-energy derived charging system for use in both grid-tied and off-grid environments to provide sustainable electrical energy for the electrical devices of campers, vacationers, and RV'ers that enables a sustainable outdoor experience, be it in the vast outdoors or in more rural environments. Ways of using the solar-energy derived charging system are also provided. The solar-energy derived charging system may be used by various entities, including campers, vacationers, and RV'ers, in combination with a habitable enclosure.

The solar-energy derived charging system may include the following aspects. The solar-energy derived charging system may include a solar array of photovoltaic cells. The photovoltaic cells may be integrated into a roof of the solar-energy derived charging system and may generate electrical energy for storage in an energy storage device integrated into a portion of the solar-energy derived charging system. The energy storage device may be configured to receive and store energy from the photovoltaic cells. The stored electrical energy may be used to charge a battery electric vehicle at selected charging rates, and/or power hotel loads such as water production and waste incineration, as well as provide power for various applications and utilities such as lights, HVAC systems, refrigeration and cooking appliances, for example. As described herein, a hotel load or hotel power may refer to an electrical load that relates to human occupancy aspects of a vehicle, RV, habitat, or other device such as air conditioning and lighting. This may also include the electrical load related to electrically powered systems of a vehicle.

The photovoltaic cells may be coupled to a rotating turntable for sun-tracking purposes where the turntable may be utilized to manually or automatically rotate the photovoltaic cells in order to maintain maximum solar energy extraction. The solar-energy derived charging system may be portable and fold and unfolds for a unique delivery, transport, and deployment experience. The solar-energy derived charging system may also be designed for manufacturability, transportability and easy deployment as the solar-energy derived charging system may be moved from the factory to on-site deployment in one continuous process.

Various management, control, and operations of the solar-energy derived charging system may include the following aspects. The solar-energy derived charging system may be equipped with a centralized, intelligent digital backbone using remote communication technologies that use, artificial intelligence (AI), and machine learning (ML) for enabling the maximum utilization of a fleet of solar-energy derived charging systems of a given solar capacity, energy storage capacity, time of year, weather forecasting, user vehicle characteristics, user trip plans, and routes. The solar-energy derived charging system may include a utility management system to monitor and control energy generation and consumption as well as monitor and control specific electrical devices such as waste management and potable water generation, for example. Trip planning and brokering of energy between a vehicle and the solar-energy derived charging system usage may include many properties that may influence optimal trip planning and solar-energy derived charging system utilization across a constellation of available solar-energy derived charging systems, weather conditions, vehicle characteristics, one or more user travel itineraries, and other available data related a planned trip.

Two or more solar-energy derived charging systems may be in electrical communication in order to provide a self-sustained micro/nano-grid of connected solar-energy derived charging systems, electric vehicles, and other electric resources for communal electrical energy distribution and management. In certain embodiments, the solar-energy derived charging system or a collection of solar-energy derived charging systems may be connected to the electric-grid and function as a distributed energy storage system, and when not utilized for habitation, may provide clean renewable energy back to the electric-grid.

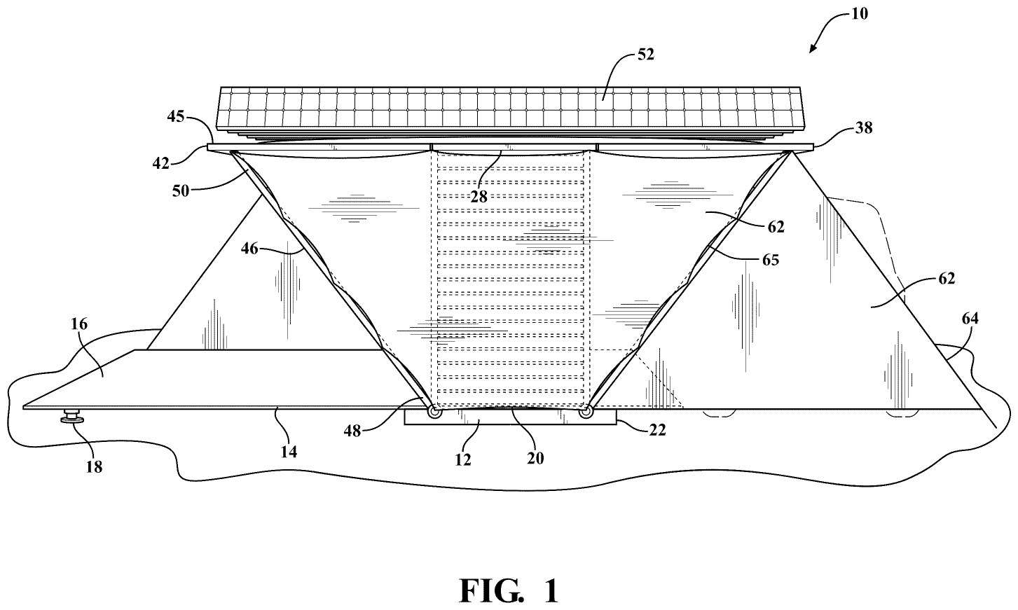

With reference to FIGS. 1-4, a solar-energy derived charging system 10 is shown for use in an off-grid environment to provide electrical power to an electrical device. The solar-energy derived charging system 10 may include a base 12 and a floor panel 14 pivotally coupled to the base 12. The floor panel 14 may be movable from a first position that is substantially perpendicular to the base 12 to a second position that is substantially parallel to the base 12 to form a floor 16 of the solar-energy derived charging system 10. One or more adjustable feet 18 (manual or electrically actuated) may be coupled to an underside of the base 12 and the floor panel 14.

In certain embodiments, each of adjustable feet 18 may be configured to contact a support surface such as the earth, the ground, or a human-made platform, for example, to support the base 12, the floor panel 14, and the overall structure of the solar-energy derived charging system 10. A vertical height of each of the adjustable feet 18 may be adjusted as desired to ensure contact with the support surface and facilitate a leveling of the floor 16. In certain embodiments, the adjustable feet 18 may be self-leveling or automated to self-level the floor 16, wherein the electrical screw motors, pneumatic adjusters, or the like may be employed to adjust the vertical height of one or more of the adjustable feet 18 independently of each other. It should be understood that the adjustable feet 18 may include a wheel or a roller, for example, to facilitate moving the solar-energy derived charging system 10. Furthermore, the wheel and/or the roller may be separate from the adjustable feet 18. In particular, the solar-energy derived charging system 10 may include any appropriately desired mechanism for leveling the solar-energy derived charging system 10.

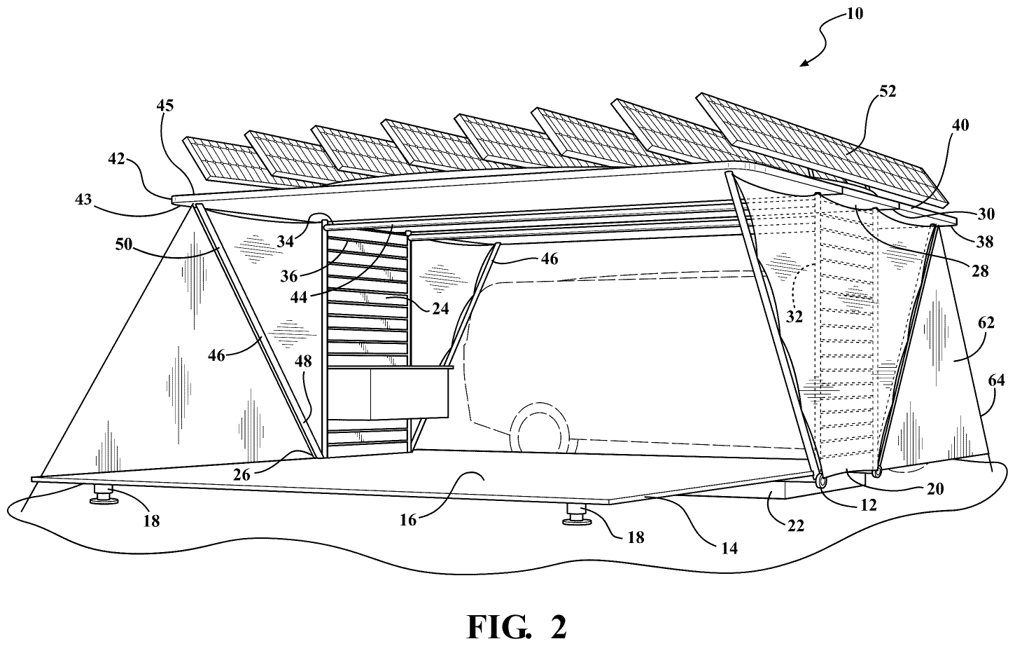

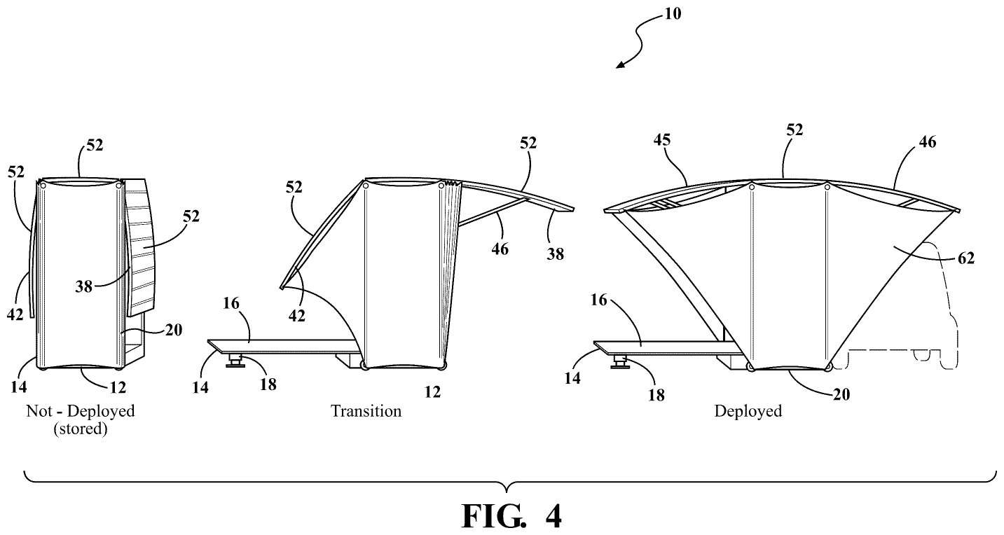

With reference to FIG. 2, a first vertical support 20 is coupled to a first end 22 of the base 12 and a second vertical support 24 is coupled to a second end 26 of the base 12. A roof panel 28 has a first end 30 coupled to an upper end 32 of the first vertical support 20 and a second end 34 coupled to an upper end 36 of the second vertical support 24. A first foldable roof panel 38 may be pivotally coupled to a first side 40 of the roof panel 28 and a second foldable roof panel 42 may be pivotally coupled to a second side 44 of the roof panel 28. The first foldable roof panel 38 and the second foldable roof panel 42 are movable from a storage position or non-deployed position that is substantially perpendicular to the roof panel 28 to a deployed position that is substantially parallel to the roof panel 28 or in alignment with the roof panel 28 to form a roof 45 that may support the solar-energy derived charging system 10, as shown in FIG. 4.

A support pole 46 may include a first end 48 and a second end 50, wherein the first end 48 is coupled to either the base 12 or one of the first vertical support 20 and the second vertical support 24. The second end 50 of the support pole 46 may be coupled to one of the first foldable roof panel 38 and the second foldable roof panel 42. As shown in FIG. 2, there are four support poles 46, one for each corner of the roof 45. It should be understood that the support pole 46 may be a telescopic pole to allow for adjusting a length of the support pole 46. Furthermore, it should be understood that the second end 50 of the support pole 46 may be coupled in a transitory manner to the first foldable roof panel 38 and the second foldable roof panel 42 to facilitate moving the first foldable roof panel 38 and the second foldable roof panel 42 from the storage position to the deployed position. It should also be understood that the first end 48 may be releasably coupled to the base 12 or one of the first vertical support 20 and the second vertical support 24. The second end 50 may be releasably coupled to the first foldable roof panel 38 and the second foldable roof panel 42.

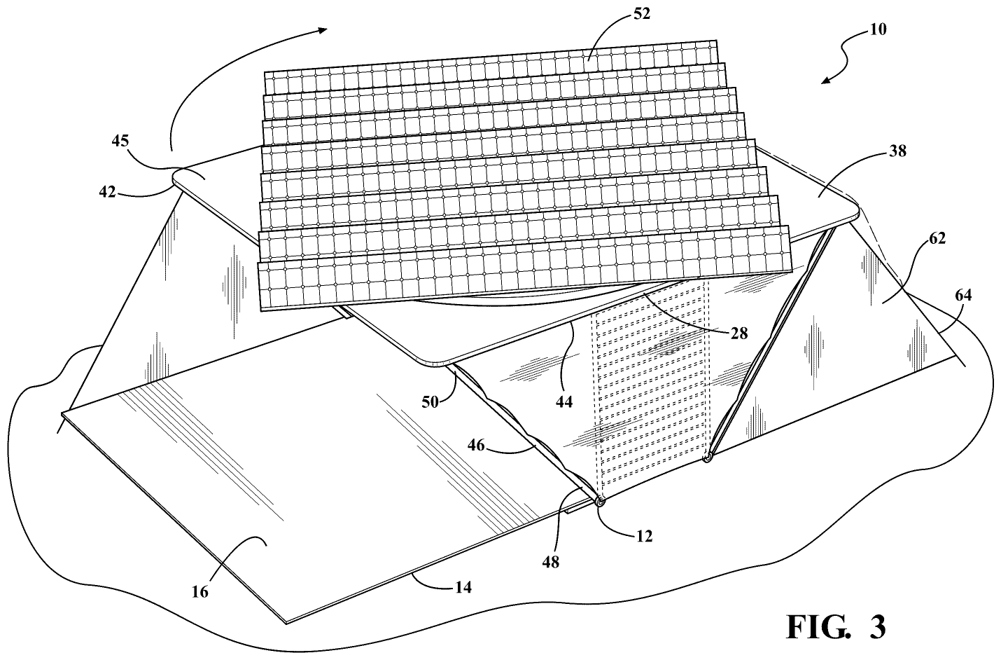

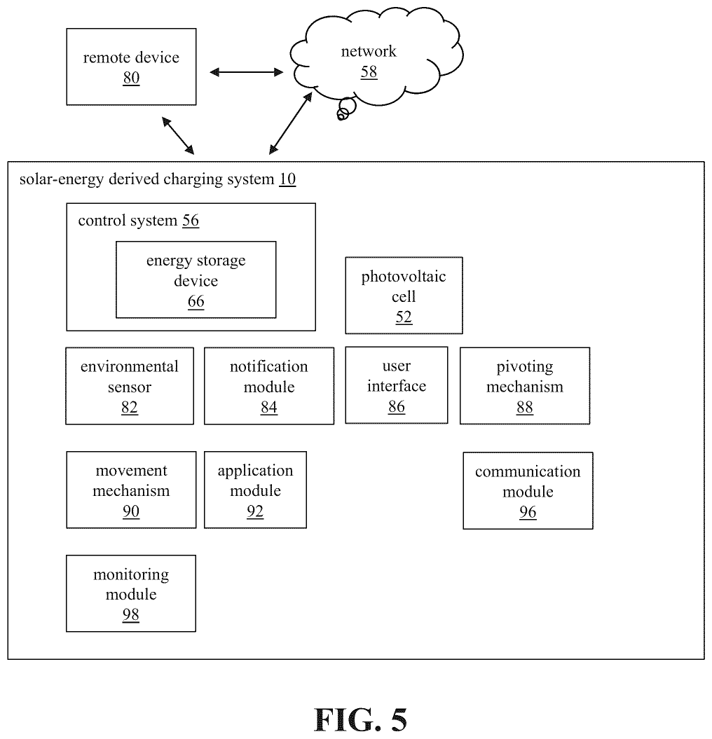

The solar-energy derived charging system 10 may include one or more photovoltaic cells 52 movably disposed on the roof panel 28, the first foldable roof panel 38, and/or the second foldable roof panel 42. As shown in FIGS. 2-3, a position of the photovoltaic cells 52 may be altered. For example, a movement mechanism 90 (FIG. 5) such as a rotatable platform or turn-table may be provided to rotate the photovoltaic cells 52 with respect to the roof panel 28. Additionally, a pivoting mechanism 88 (FIG. 5) may be provided to move the photovoltaic cells 52, or sub-sets of the photovoltaic cells 52, from a position that is substantially parallel to the roof panel 28, denoted as zero-degrees, to a position that is no longer parallel to the roof-panel, denoted as an angle between zero degrees and 90-degrees or more. The movement of the photovoltaic cells 52 may be used to track the sun during the day to maximize the generation of electrical energy from the photovoltaic cells 52. It should be understood that the photovoltaic cells 52 may be manually or automatically moved to track the sun during the day.

The solar-energy derived charging system 10 may also include a sail panel 62, where the sail panel 62 may be configured to be coupled to structural components of the solar-energy derived charging system 10 to provide partitions or walls at selected locations around or within the solar-energy derived charging system 10. For example, the sail panel 62 may include a peripheral edge 65 coupled to one of the first foldable roof panel 38 and the second foldable roof panel 42 and an adjacent one of the first vertical support 20 and the second vertical support 24. The sail panel 62 accordingly may provide shade, privacy, and protection from the environment. In certain embodiments, the sail panel 62 may be formed from a generally flexible fabric material. In other embodiments, the sail panel 62 may be formed from a rigid or semi-rigid material. It should be understood that the sail panel 62 may be moveably coupled to the structural components of the solar-energy derived charging system 10 to allow for an adjustable area of the sail panel 62, including from being fully retracted to being partially deployed or fully deployed to maximize the area of the sail panel 62.

Referring now to FIG. 5, a block diagram of an additional embodiment of a solar-energy derived charging system 10 is depicted therein. As described herein and above, the solar-energy derived charging system 10 may be configured for use in an off-grid or grid-tied environment to provide electrical power to an electrical device. The solar-energy derived charging system 10 may include a control system 56, an application module 92, and a photovoltaic cell 52. In certain embodiments, the control system 56 may be configured to receive a user input, such as a travel itinerary and a destination. The application module 92 may be integrated with and/or configured to communicate with the control system 56 in order to manage an energy allocation from the solar-energy derived charging system based upon the travel itinerary and destination, where the energy allocation may account for an energy availability and an environmental condition based on the travel itinerary and destination. A photovoltaic cell 52 may be configured to charge an energy storage device 66 managed by the control system 56 to provide an energy supply. In certain embodiments, a pivoting mechanism 88 and/or a movement mechanism 90 may be utilized to move the photovoltaic cell 52 and/or the photovoltaic cells 52 based on the environmental condition.

In certain embodiments, a sensor, such as an environmental sensor 82 may be configured for a real-time monitoring of the environmental condition. The control system 56 may be configured to adjust a positioning of the photovoltaic cells 52 in response to a change in the environmental condition to provide the energy supply. A user interface 86 may be configured to receive the user input including the travel itinerary. The application module 92 may be configured to predict a potential energy generation and adjust an energy storage rate and an energy discharge rate based on the weather forecast data to ensure an ideal amount of energy availability. In certain embodiments, the application module 92 may be configured to modify the energy allocation based on a real-time energy generation and consumption data. A notification module 84 may be configured to provide a notification to a user based on change to the energy storage of the solar-energy derived charging system 10.

As further shown in FIG. 5, a communication module 96 may enable the control system 56 to communicate with a remote device 80. For example, the communication module 96 may enable a user to input the travel itinerary and the destination using a software application of the remote device 80. In certain embodiments, the communication module 96 may be configured to wirelessly communicate with the remote device 80, where the remote device 80 may be configured to receive and store a data from the solar-energy derived charging system 10. The remote device 80 may be in further communication with the remote network 58. A monitoring module 98 may further be configured to monitor a state of charge of the energy storage device 66 and manage a distribution of stored energy based on a priority setting. The application module 92 may be configured to modify the energy allocation based on a real-time energy generation and consumption data.

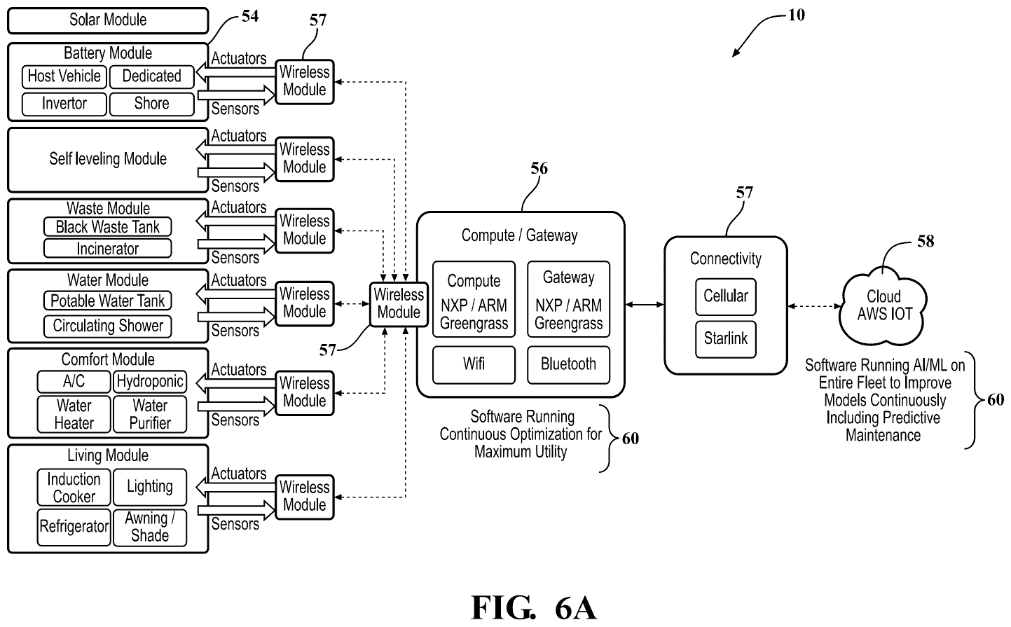

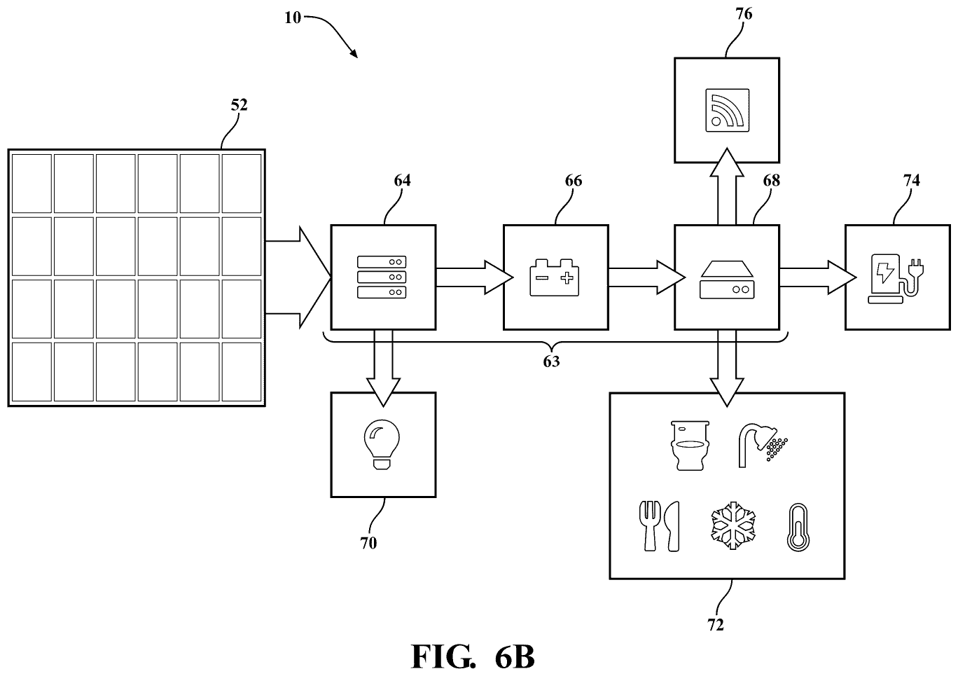

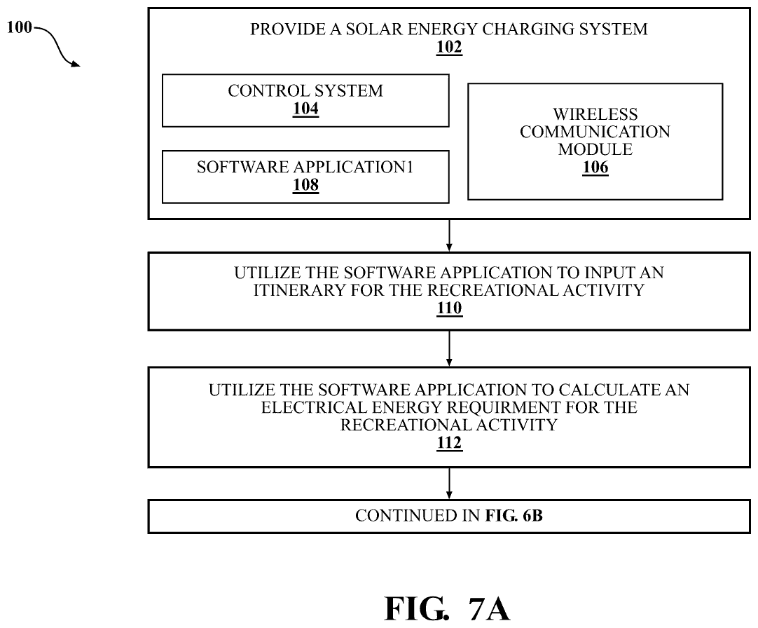

The energy storage device 66, such as shown within in FIG. 6B, may be provided that may be in electrical communication with the photovoltaic cells 52, the energy storage device 66 may be configured to receive and store electrical energy from the photovoltaic cells 52 and may provide electrical energy to electrical devices connected thereto. In certain embodiments, the energy storage device 66 may supply electrical energy to charge an electric vehicle or energize other electrical devices such as lights, water heaters, water pumps, air conditioners, cooking appliances, air compressors, electronic devices, and waste disposal systems, known as hotel loads, such as described above, for example. Additionally, other electrical components may be provided such as an inverter 68 and a transformer, for example, to provide a desired output current and voltage from the energy storage device 66. Furthermore, the energy storage device 66 may be in communication with an electrical-grid or one or more other solar-energy derived charging systems 10, where electrical energy may be supplied to or derived from the electrical-grid and one or more other solar-energy derived charging systems 10.

As further shown within FIG. 6A, the solar-energy derived charging system 10 may include a control system 56. The control system 56 may be configured to monitor and control the operation of the solar-energy derived charging system 10. For example, the control system 56 may be utilized to control the position of the photovoltaic cells 52, the generation of electrical energy by the photovoltaic cells 52, a state of charge of the energy storage device 66, and/or the rate of discharge of the energy storage device 66. Furthermore, the control system 56 may include a wireless communication module 57 configured to provide communication between the control system 56 and a remote network 58, between the control system 56 and other components of the solar-energy derived charging system 10, and/or between the control system 56 and the electrical devices being powered by the solar-energy derived charging system 10. The remote network 58 may be configured to receive and/or store data from the solar-energy derived charging system 10. Additionally, the control system 56 may be in communication with the control system 56 of one or more other solar-energy derived charging systems 10, where a shared resource, such as a water supply or a waste disposal system, for example, may be utilized by each solar-energy derived charging system 10. It should be appreciated that the associated electrical devices may be monitored and controlled by the control system 56 or one or more of the electrical devices may be provided with a module configured to provide communication between the electrical device and the remote network 58, the remote network 58 may be configured to receive and/or store data from the electrical device and, in some embodiments, control an operation of the electrical device.

The solar-energy derived charging system 10 may also include a software application 60 configured to utilize the data to perform selected calculations and generate certain reports, for example. The software application 60 may also receive a secondary source of information related to weather conditions, a weather forecast, a user travel itinerary, an electrical consumption profile of the user electric vehicle and other user electrical devices, and geographical data, wherein the secondary source of information may be utilized to perform specific calculations and generate predetermined data of interest. In certain embodiments, the data and the secondary source of information may be utilized by the software application 60 to facilitate efficient operation of the solar-energy derived charging system 10 and to monitor and manage the generation and use of electrical energy from the solar-energy derived charging system 10. It should be understood that the software application 60 may be an internet/cloud based application that is accessible through mobile electronic devices or another electronic devices having communication capabilities with the internet or other device hosting the software application 60.

In certain embodiments, the software application 60 may be configured to manage a fleet of the solar-energy derived charging systems 10. It should be understood that the functionality to manage a fleet of the solar-energy derived charging system 10 may be a software application that is separate from the software application 60 or only accessible by an authorized user, such as an owner or manager of the fleet of the solar-energy derived charging system 10, wherein a user (e.g., traveler/renter/non-owner) cannot access such functionality. The functionality to manage the fleet of the solar-energy derived charging systems 10 may include monitoring the operations, scheduling maintenance, detecting maintenance issues, tracking occupancy, and managing rental pricing and reservations, for example. Additionally, in certain embodiments, the authorized user may receive alerts, including alerts related to exhaustion of energy storage and alerts initiated by the user for user assistance and/or requesting emergency services, for example.

FIG. 6B shows a schematic drawing of the solar-energy derived charging system 10. The embodiment shown in FIG. 6B may be used to perform system simulations of the solar-energy derived charging system 10 being utilized in an outdoor camping environment. Specifically, the embodiment shown in FIG. 6B includes the array of photovoltaic cells 52 (or photovoltaic (PV) module array) in electrical communication with an energy storage system or ESS 63. The ESS 63 may include a charge controller 64, an energy storage device 66 (e.g., battery), and an inverter 68. The charge controller 64 may be in electrical communication with LED lights 70. The inverter 68 may be in electrical communication with electrically powered amenities 72 (e.g., an electric device such as a toilet, shower, cooking appliance, and HVAC devices), a battery electric vehicle charger and/or electric vehicle charger 74, and a system 76 for controlling and monitoring the electrical components and the entirety of the solar-energy derived charging system 10, including a network and/or network communication components.

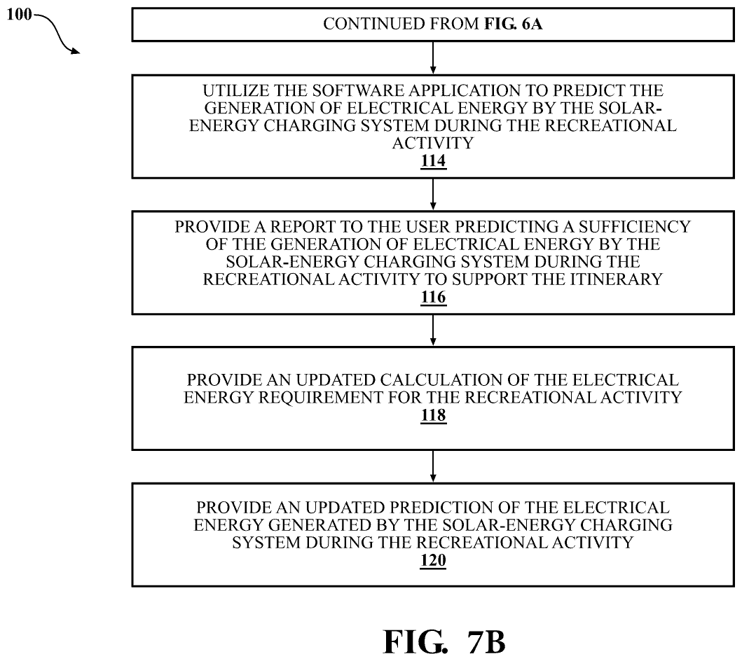

A method 100 for planning a recreational activity by a user is shown in FIGS. 7A-7B, where the method 100 may include a step 102 of providing the solar-energy derived charging system 10 to generate, store, and provide electrical energy to one or more electrical devices. It should be understood that other solar-energy charging systems and solar-energy electrical generation systems may be utilized for the method 100, wherein, for example, a module is configured to coordinate with the other energy systems to collect and communicate electrical generation and/or usage related data. It should be appreciated that the following steps may occur in various consecutive orders with respect to each other, including where certain steps may be performed simultaneously, or with other steps. In step 104, a control system is provided that may be configured to monitor and control at least one of a generation of electrical energy by the solar-energy derived charging system and the use of electrical energy provided by the solar-energy derived charging system. In step 106, a wireless communication module is provided that may be configured to provide communication between the control system and a remote network, the remote network may be configured to receive and store data from the solar-energy derived charging system. A software application may be provided in step 108, wherein the software application may be hosted on a remote network and configured to utilize the data, and a secondary source of data related to a weather condition, a weather forecast, a user travel itinerary, an electrical device consumption profile, and/or geographical data. The data and the secondary source of information may be utilized to control the operation of the solar-energy derived charging system 10 and manage the use of electrical energy from the solar-energy derived charging system 10.

The method 100 may also include step 110 of a user utilizing the software application to input an itinerary for the recreational activity, where the itinerary may include information such as date(s) and location(s) for the recreational activity, travel routes, number of people and pets that will participate in the recreational activity, and the electrical devices that will be used during the recreational activity. The user may include other information in the itinerary that could impact electrical energy required for the recreational activity as well as other information that may be helpful to the user to plan and schedule the recreational activity. It should be understood that the software may also be configured to contact one or more third party service providers such as camping, vehicle, and equipment rental providers to facilitate the user making reservations for such services according to the itinerary. It should also be understood that the itinerary may include travel between and stays at different locations, where the locations may include the solar-energy derived charging system 10, a traditional on-grid location, and/or a combination thereof.

In step 112, the software application may be utilized to calculate an electrical energy requirement for the recreational activity using secondary sources of data such as the user itinerary. In step 114, the software application may be utilized to predict the generation of electrical energy by the solar-energy derived charging system during the recreational activity using a secondary source of data, including the user itinerary and weather-related data. A report may be provided to the user in step 116 that provides the prediction of a sufficiency of the generation of electrical energy by the solar-energy derived charging system 10 during the recreational activity to support the user itinerary. The prediction of the sufficiency of the generation of electrical energy by the solar-energy derived charging system 10 may include a difference between the calculation of the electrical energy requirement and the prediction of the electrical energy generated by the solar-energy derived charging system 10 during the recreational activity. The user may use the report to determine if adjustments need to be made to their recreational activity to minimize the chance of running out of electrical energy or take advantage of excess electrical energy. If desired, the user may input a change to the itinerary in step 116 to obtain an updated prediction of the sufficiency of the electrical energy generated by the solar-energy derived charging system 10 during the recreational activity to support the change to their itinerary. Furthermore, the report from the software application may include options or suggestions for changing the itinerary to minimize running out of electrical energy and/or take advantage of excess electrical energy during their recreational activity. For example, the software may include artificial intelligence and/or machine learning to provide an optimized itinerary based on the desired activities and available resources, including the predicted electrical energy available.

The method 100 may also include steps for monitoring and controlling the use of electrical energy during the recreational activity. In step 118, an updated calculation of the electrical energy requirement for the recreational activity or a remainder of the recreational activity is provided. The updated calculation of the electrical energy requirement may be used to update the prediction of the sufficiency of the electrical energy during a remaining portion of the recreational activity. It should be understood that the updated prediction may be provided to the user in a report or alert according to a predetermined schedule as well as being generated on demand by the user. The updated prediction and/or report may include a difference between the calculation of the electrical energy requirement and the prediction of the electrical energy generated by the solar-energy derived charging system 10 during the remaining portion of the recreational activity. The updated prediction and/or report may also include options and/or suggestions for reducing or increasing the rate of use of the electrical energy generated by the solar-energy derived charging system. Furthermore, in certain circumstances, the software application may be configured to shut-off certain electrical devices in a specific order to conserve electrical energy for other more critical electrical devices, and alternatively the user may define critical electrical devices to help ensure that such critical electrical devices will have adequate electrical energy for the duration of the recreational activity.

Additionally, the method 100 may include step 120 of monitoring the secondary source of data, including weather related data, to calculate changes to the prediction of the electrical energy that will be generated by the solar-energy derived charging system 10. The changes to the prediction of the electrical energy that will be generated by the solar-energy derived charging system 10 may be shown in a report or alert, which may provide the user with an updated prediction of the sufficiency of the electrical energy generated by the solar-energy charging system during the recreational activity or a remaining portion of the recreational activity. The updated prediction and/or report may include a difference between the calculation of the electrical energy requirement and the updated prediction of the electrical energy generated by the solar-energy derived charging system 10 during the recreational activity or a remaining portion of the recreational activity. The updated prediction and/or report may include options and/or suggestions for reducing or increasing the rate of use of the electrical energy generated by the solar-energy derived charging system 10. Furthermore, in certain circumstances, the software application may be configured to shut-off certain electrical devices to conserve electrical energy for other electrical devices, where the user may define critical electrical devices to help ensure that such critical electrical devices will have adequate electrical energy for the duration of the recreational activity.

### EXAMPLES

A simulation of the solar-energy derived charging system 10 and operation of the associated components shown in FIG. 6B may be based on the following parameters and requirements:
Two-night habitation duration
Location: Campsite at Sleeping Bear Dunes in the State of Michigan
Season: April-October (weeks 14-39)
04:00 pm check-in, 11:00 am check-out (Total of 43 hours)
Energy Storage System is fully charged at check-in
100 kWh capacity electric vehicle arrives 20% charged
Vehicle charging starts at 08:00 pm
Vehicle charging stops at 04:00 am or <10% Solar-Energy Derived charging system Energy Storage System State of Charge (SOC)
Hotel loads (˜20 kWh per day)
Vehicle battery capacity of 100 kWh with 90% depth of discharge (DoD)
24-450 W Photovoltaic cells 52 facing south with 38° tilt
Inverter 68 at 96% efficiency

Additional parameters used in the simulations or some embodiments of the solar-energy derived charging system 10 shown in FIG. 5B for the photovoltaic cells 52, the charge controller 64, the energy storage device 66 and the inverter 68 are as follows:
The Photovoltaic Cells 52
   Individual Photovoltaic (PV) Modules
      Provide >460 W under standard test conditions
      Have a power tolerance of +5/−0%
      Have a conversion efficiency of >22%
      Have a power drift coefficient of <0.3%/° C.
   PV Array
      Support 24 PV modules arranged in a 4×6 unit grid.
      Ability to point south, regardless of the orientation of the Canopy, within ±20° accuracy when deployed
      Ability to tilt up to 45° or tilt to match the local latitude when deployed
      Withstand local wind conditions when deployed
Charge Controller 64
   High efficiency, Direct Current (DC)
   Prevent energy storage system overcharging and block reverse current back feed to the PV array
   Limit the energy storage system from over-discharge
   Protect from electrical overloads
   Provide temperature compensation to set-points
   Integrate with the system 76
   Provide a nominal 12 or 24 VDC output for lighting
   Maximum Power Point Tracking (MPPT) controller
Energy Storage System and other Energy Sources
   Provide a minimum of 100 kWh of energy storage or constant source supply.
   Allow for at least a 90% depth of discharge for a fixed capacity energy storage system.
   May utilize a Lithium Iron Phosphate (LiFePO4), Sodium Ion (Na+) or other chemical battery chemistry or a combination of different chemistries.
   May utilize a Flywheel Energy Storage System (FESS) as an energy storage device.
   May utilize a hydro-electric generator system as the constant energy source.
   May utilize a wind energy generator as the constant energy source.
   May utilize a combination of all of the above or other energy storage/generation devices.
Inverter 68
   Provide >12 kW of continuous power
   Provide >36 kW of peak power
   Output 50/60 Hz sine wave AC with <7% total harmonic distortion under continuous load
   Provide >97% DC to AC conversion efficiency

Two-thousand (2,000) Monte Carlo simulations (used to model a probability of a different outcome) of camping stays were performed where check-in date and amenity load use times were randomized with a uniform distribution. Advantageously, in the simulations, the solar-energy derived charging system 10 shown in FIG. 6B provided enough electrical power to energize the LED lights 70, the electrically powered amenities 72, and the electric vehicle charger 74 during the two night stay, including charging the electric vehicle for the trip home. It should be understood that the solar-energy derived charging system 10 may include components having other specifications, capabilities, configurations, and the like, from those described and tested in the Monte Carlo simulations.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. A solar-energy derived charging system for use in an off-grid or grid-tied environment to provide electrical power to an electrical device for a user, the solar-energy derived charging system comprising:
a control system configured to receive a user input including a travel itinerary;
an application module integrated with the control system, the application module configured to manage an energy allocation from the solar-energy derived charging system based upon the user input including the travel itinerary, the energy allocation accounting for an energy availability and an environmental condition based on the travel itinerary; and
a plurality of photovoltaic cells configured to charge an energy storage device managed by the control system to provide an energy supply to an electrical device for a user.

2. The solar-energy derived charging system of claim 1, further comprising a sensor configured for real-time monitoring of the environmental condition, wherein the control system is configured to adjust a positioning of the plurality of photovoltaic cells in response to a change in the environmental condition to provide the energy supply.

3. The solar-energy derived charging system of claim 1, further comprising a user interface in communication with the control system, the user interface configured to receive the user input including the travel itinerary.

4. The solar-energy derived charging system of claim 1, wherein the environmental condition includes a weather forecast data, the application module configured to predict a potential energy generation and adjust an energy storage rate and an energy discharge rate based on the weather forecast data to ensure an ideal amount of energy availability.

5. The solar-energy derived charging system of claim 1, further comprising a communication module integrated with the control system, the communication module configured to allow the control system to communicate with a remote device.

6. The solar-energy derived charging system of claim 1, further comprising a monitoring module integrated with the control system, the monitoring module configured to monitor a state of charge of the energy storage device and manage a distribution of stored energy based on a priority setting.

7. The solar-energy derived charging system of claim 1, wherein the application module is configured to modify the energy allocation based on a real-time energy generation and consumption data.

8. The solar-energy derived charging system of claim 1, wherein the control system is configured to monitor and control a member selected from a group consisting of a position of the plurality of photovoltaic cells, a generation of electrical energy by the plurality of photovoltaic cells, a wind generator, a hydro-electric generator, a state of charge of the energy storage device, a rate of discharge of the energy storage device, and combinations thereof.

9. The solar-energy derived charging system of claim 5, wherein the communication module is configured to wirelessly communicate with the remote device, the remote device configured to receive and store a data from the solar-energy derived charging system.

10. The solar-energy derived charging system of claim 1, wherein the solar-energy derived charging system is in electrical communication with another solar-energy derived charging system.

11. The solar-energy derived charging system of claim 1, wherein the solar-energy derived charging system is in electrical communication with an electrical grid.

12. The solar-energy derived charging system of claim 1, wherein the solar-energy derived charging system includes a pivoting mechanism configured to pivot the plurality of photovoltaic cells.

13. The solar-energy derived charging system of claim 1, wherein the solar-energy derived charging system includes a movement mechanism configured to rotate the plurality of photovoltaic cells with respect to a roof panel.

14. The solar-energy derived charging system of claim 1, wherein the solar-energy derived charging system includes
a base;
a floor panel pivotally coupled to the base;
a plurality of adjustable feet coupled to the base and the floor panel, the plurality of adjustable feet configured to contact a ground surface and support the base and the floor panel;
a first vertical support coupled to a first end of the base and a second vertical support coupled to a second end of the base;
a roof panel having a first end and a second end, the first end coupled to an upper end of the first vertical support, and the second end coupled to an upper end of the second vertical support;
a first foldable roof panel pivotally coupled to a first side of the roof panel and moveable between a deployed position and an undeployed position;
a second foldable roof panel pivotally coupled to a second side of the roof panel and moveable between a deployed position and an undeployed position;
a support pole configured to independently support one of the first foldable roof panel and the second foldable roof panel when each are in the deployed position, the support pole having a first end and a second end, the first end coupled to one of the base, the first vertical support, and the second vertical support, and the second end coupled adjacent to one of a second side of the first foldable roof panel and a second side of the second foldable roof panel;
the plurality of photovoltaic cells disposed on the roof panel, the first foldable roof panel, and the second foldable roof panel; and
an energy storage device in electrical communication with the plurality of photovoltaic cells, the energy storage device configured to receive and store energy from the plurality of photovoltaic cells and provide energy to the electrical device.

15. A method for providing energy for a recreational activity by a user, the method comprising:
providing the solar-energy derived charging system of claim 1;
utilizing a software application to input an itinerary for the recreational activity;
utilizing the software application and a secondary source of data to calculate an electrical energy requirement for a user itinerary;
utilizing the software application and a secondary source of data to predict a generation of electrical energy by the solar-energy derived charging system during the recreational activity;
providing a report to the user predicting a sufficiency of the generation of electrical energy by the solar-energy derived charging system during the recreational activity to support the user itinerary; and
operating the solar-energy derived charging system to provide energy for the user itinerary based on the recreational activity.

16. A method for planning a recreational activity by a user, the method comprising:
providing a solar-energy derived charging system for use in an off-grid or grid-tied environment to provide electrical energy to an electrical device, the solar-energy derived charging system including,
a control system configured to monitor and control a generation of electrical energy by the solar-energy derived charging system and a use of electrical energy from the solar-energy derived charging system,
a wireless communication module configured to provide communication between the control system and a remote network, the remote network configured to receive and store data from the solar-energy derived charging system, and
a software application configured to utilize the data and a secondary source of data, the secondary source of data including a member selected from a group consisting of a weather condition, a weather forecast, a user travel itinerary, an electrical consumption profile of the electrical device, geographical data, and/or combinations thereof,
utilizing the software application to input an itinerary for the recreational activity;
utilizing the software application and the secondary source of data to calculate an electrical energy requirement for the recreational activity;
utilizing the software application and the secondary source of data to predict the generation of electrical energy by the solar-energy derived charging system during the recreational activity;
providing a report to the user predicting a sufficiency of the generation of electrical energy by the solar-energy derived charging system during the recreational activity to support the user travel itinerary; and
adjusting an operation of a plurality of photovoltaic cells and the solar-energy derived charging system to optimize energy efficiency and meet predicted energy requirements based upon the user travel itinerary.

17. The method of claim 16, including inputting a change to the user travel itinerary to predict the sufficiency of the electrical energy generated by the solar-energy derived charging system during the recreational activity to support the change to the user travel itinerary.

18. The method of claim 17, further comprising monitoring of the use of electrical energy during the recreational activity and providing the user with an updated prediction of the sufficiency of the electrical energy generated by the solar-energy derived charging system during a remaining portion of the recreational activity.

19. The method of claim 18, wherein the updated prediction includes a difference between a calculation of the electrical energy requirement and a prediction of the electrical energy generated by the solar-energy derived charging system during the recreational activity.

20. The method of claim 18, wherein the updated prediction includes options for reducing or increasing a rate of use of the electrical energy generated by the solar-energy derived charging system.
